(19) United States
(12) Patent Application Publication
(10) Pub. No.: US 2026/0095502 A1
(43) Pub. Date: Apr. 2, 2026

(54) DYNAMIC WORKLOAD MIGRATION IN A DECENTRALIZED HIERARCHICAL CONTROL PLANE FOR VIRTUALIZATION MANAGEMENT IN EDGE DEVICES AND HYBRID CLOUD ENVIRONMENTS

(71) Applicant: Red Hat, Inc., Raleigh, NC (US)

(72) Inventors: Christian Pinto, Dublin (IE); Srikumar Venugopal, Dublin (IE); Leigh Griffin, Waterford (IE); Stephen Coady, Dublin (IE)

(21) Appl. No.: 18/903,773

(22) Filed: Oct. 1, 2024

(51) Int. Cl. H04L 67/1025; H04L 41/00; H04L 41/044; H04L 67/101

(52) U.S. Cl. CPC H04L 67/1025; H04L 41/044; H04L 41/30; H04L 67/101

(57) ABSTRACT

Aspects of the present disclosure relate to dynamic workload migration in a decentralized hierarchical control plane for management in edge devices and hybrid cloud environments. More specifically, a processing device obtains an indication of a workload associated with a decentralized hierarchical control plane, where the decentralized hierarchical control plane includes a plurality of control nodes in a decentralized hierarchy. The processing device determines, based on data associated with the decentralized hierarchy, a target for migration of the workload. The processing device causes the workload to be migrated to the target.

### TECHNICAL FIELD

Aspects of the present disclosure relate to cloud and edge computing, and more particularly, to dynamic workload migration in a decentralized hierarchical control plane for management in edge devices and hybrid cloud environments.

### BACKGROUND

Cloud computing refers to a paradigm by which computing services/resources, such as servers, storage, databases, networking, software, analytics, and intelligence, are delivered over the Internet to user devices. Cloud computing may be characterized by on-demand self-service (i.e., the cloud can automatically provision resources without human interaction with a service provider), broad network access (i.e., the cloud can be accessed by different devices with varying capabilities, such as mobile phones, tablets, smartphones, laptops, and workstations), resource pooling (i.e., the cloud can serve multiple different clients), rapid elasticity (i.e., the cloud can dynamically scale computing resources both upwards and downwards based on needs of clients), and measured service (i.e., the cloud monitors computing resources used by clients). Some clouds may be distributed over multiple centers across disperse geographic locations. A cloud may be a public cloud (i.e., a cloud that utilizes a shared infrastructure) or a private cloud (i.e., a cloud that utilizes an infrastructure of an organization). Compared to other types of computing paradigms, cloud computing may provide various advantages to clients, such as scalability, performance increases, device independence, decreased maintenance, and increased availability.

Edge computing refers to a distributed computing model that brings computation and data storage to a location of a source of data. In an example, edge computing seeks to distribute computation to devices (i.e., edge devices) located physically closer to a user device so as to reduce latency compared to a situation in which a centralized data center (e.g., a centralized data center belonging to a cloud) executes an application for the user device. A hybrid cloud refers to a mixed computing environment in which applications run using a combination of computing, storage, and services in different environments including public clouds and private clouds, on-premises data centers, and edge devices.

### BRIEF DESCRIPTION OF THE DRAWINGS

The described aspects and the advantages thereof may best be understood by reference to the following description taken in conjunction with the accompanying drawings. These drawings in no way limit any changes in form and detail that may be made to the described aspects by one skilled in the art without departing from the spirit and scope of the described aspects.

FIG. 1 is a block diagram that illustrates an example of a decentralized hierarchical control plane for management in edge devices and hybrid cloud environments in accordance with some aspects of the present disclosure.

FIG. 2 is a block diagram that illustrates an example of workload migration in accordance with some aspects of the present disclosure.

FIG. 3A is a block diagram that illustrates an example of determining a target for migrating a workload in accordance with some aspects of the present disclosure.

FIG. 3B is a block diagram that illustrates an example of determining a route for migrating a workload to a target in accordance with some aspects of the present disclosure.

FIG. 4 is a block diagram that illustrates an example system in accordance with some aspects of the present disclosure.

FIG. 5 is a flow diagram of a method for workload migration in accordance with some aspects of the present disclosure.

FIG. 6 is a block diagram of an example of a computer system that may perform one or more of the operations described herein in accordance with some aspects of the present disclosure.

### DETAILED DESCRIPTION

A control plane may refer to a part of a network that is responsible for configuring and managing resources in the network and/or behaviors in the network. In an example, a control plane may include a network topography, routers, switches, etc. A control plane may enforce various policies pertaining to the network such as access control, quality of service, security rules, etc. A control plane may also allocate resources in/across a network. For instance, a control plane may balance resources (e.g., bandwidth resources, storage resources) across the network so that a particular portion of the network is not overloaded.

A hybrid cloud refers to a mixed computing environment in which applications run using a combination of computing, storage, and services in different environments including public clouds and private clouds, on-premises data centers, and edge devices. A control plane for a hybrid cloud may be a centralized control plane in which policies are enforced and/or resources are allocated by a central node, that is, the central node may manage all aspects of a managed device throughout a life cycle of the device, such as policies and/or resource allocation. In contrast, a decentralized control plane, such as a decentralized hierarchical control plane that includes a plurality of layers, does not have a centralized node that manages all aspects of a managed device. Instead, a decentralized control plane, such as a decentralized hierarchical control plane that includes a plurality of layers, management decisions are distributed across multiple control nodes (e.g., control nodes in different layers of the plurality of layers).

In some networks (e.g., a network with a centralized control plane, a network with a decentralized control plane, etc.), scenarios may arise that may create a need to redistribute a workload (i.e., a computational process). For example, a node (e.g., an edge device) in a network may fail (e.g., due to a battery of the node being empty). Some control planes may have static rules and/or predetermined policies that dictate how a workload is to be redistributed in the network. For example, a control plane may be configured to redistribute a workload to a node that is located geographically closest to a failed node that was previously executing the workload. In another example, a control plane may be configured to redistribute a workload to a node that is under a relatively low computational load. However, redistributing workloads based on static rules and/or predetermined policies may sometimes result in an inefficient use of computing resources. For instance, redistributing a workload to a geographically closest node to a failed node may be sub-optimal if the geographically closest node will run out of battery while executing the workload. While a control plane may be configured with multiple sets of static rules and/or predetermined policies (e.g., redistribute a workload to a geographically closest node that has a battery level above a certain threshold level), the multiple sets of static rules and/or predetermined policies may still not be able to account for the wide variety of changing conditions a network may encounter, particularly when the network includes diverse types of devices of different capabilities distributed across different geographic areas.

The present disclosure addresses the above-noted and other deficiencies by using a processing device to perform dynamic workload migration in a decentralized hierarchical control plane for management in edge devices and hybrid cloud environments. In an example, the processing device obtains an indication of a workload associated with a decentralized hierarchical control plane, where the decentralized hierarchical control plane includes a plurality of control nodes in a decentralized hierarchy. The processing devices determines, based on data associated with the decentralized hierarchy, a target for migration of the workload. The processing device causes the workload to be migrated to the target.

The present disclosure provides for various technical advantages. For example, vis-à-vis determining, based on data associated with the decentralized hierarchy, a target for migration of the workload and causing the workload to be migrated to the target, a processing device may cause the workload to be migrated to a target (e.g., an edge device, a cloud resource, etc.) that is suitable for executing the workload, which may conserve computing resources (e.g., memory usage, processor clock cycles, network bandwidth, etc.) by selecting a target based on a variety of factors from different portions of the decentralized hierarchy. For instance, in comparison to the above-described of static rule and/or predetermined policy based approach for migrating a workload, the present disclosure is more flexible and facilitates a “just-in-time” selection of a target for executing the workload that accounts for varying network conditions. In some examples, the data associated with the decentralized hierarchy may be or may be based on a consensus of the plurality of control nodes. By using the consensus of the plurality of control nodes, the present disclosure may facilitate the selection of a suitable target for migration of the workload even when an individual control node in the plurality of control nodes does not have a full view of a state of the network.

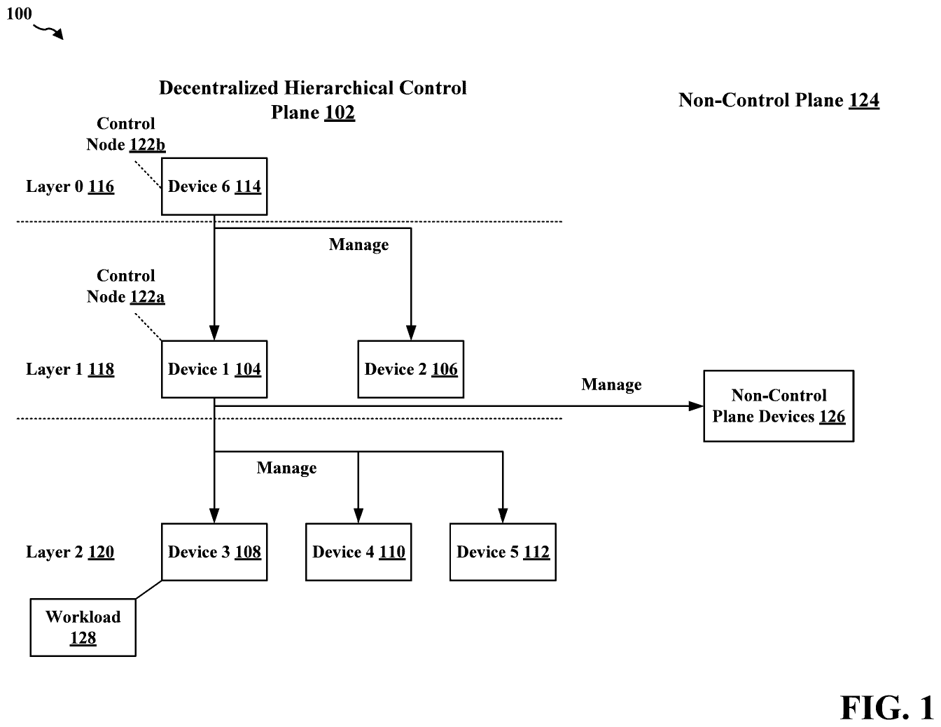

FIG. 1 is a block diagram 100 that illustrates an example of a decentralized hierarchical control plane 102 for management in edge devices and hybrid cloud environments in accordance with some aspects of the present disclosure. In the example depicted in the block diagram 100, the decentralized hierarchical control plane 102 includes a first device 104, a second device 106, a third device 108, a fourth device 110, a fifth device 112, and a sixth device 114. The first device 104, the second device 106, the third device 108, the fourth device 110, the fifth device 112, and the sixth device 114 may be collectively referred to as a plurality of devices 104-114.

In some aspects, each of the plurality of devices 104-114 may be a same type of device (e.g., each of the plurality of devices 104-114 may be edge devices). In other aspects, the plurality of devices 104-114 may include different device types. For example, the first device 104 may be a first device type (e.g., an edge device) and the second device 106 may be a second device type (e.g., a device associated with a cloud infrastructure), where the first device type and the second device type may be different. In another example, the first device 104 may be a first device type and the third device 108 may be a second device type, where the first device type is different from the second device type. In some aspects, the plurality of devices 104-114 may include edge device(s) located near user device(s), device(s) associated with a cloud infrastructure, Internet-of-Things (IoT) device(s), and/or device(s) associated with a hybrid cloud infrastructure.

In some aspects, one or more of the plurality of devices 104-114 may perform virtualization. For example, one or more of the plurality of devices 104-114 may execute a virtual machine or a container. In some aspects, one or more of the plurality of devices 104-114 may perform bare metal virtualization in which no operating system exists between hardware and virtualization software.

The plurality of devices 104-114 may communicate with one another (and/or with other devices) via a network. The network may be a public network (e.g., the internet), a private network (e.g., a local area network (LAN) or a wide area network (WAN)), or a combination thereof. In one example, the network may include a wired or a wireless infrastructure, which may be provided by one or more wireless communications systems, such as a WiFi™ hotspot connected with the network and/or a wireless carrier system that can be implemented using various data processing equipment, communication towers (e.g., cell towers), etc. The network may carry communications (e.g., data, message, packets, frames, etc.) between the plurality of devices 104-114 (and/or between the other devices). The plurality of devices 104-114 may include hardware such as processing devices (e.g., processors, central processing units (CPUs)), memory (e.g., random access memory (RAM), storage devices (e.g., hard-disk drives (HDDs)), and solid-state drives (SSDs), etc.), and other hardware devices (e.g., sound cards, video cards, etc.). The plurality of devices 104-114 may include sensors (e.g., temperature sensors, moisture sensors, etc.). A storage device may include a persistent storage that is capable of storing data. A persistent storage may be a local storage unit or a remote storage unit. Persistent storage may be a magnetic storage unit, an optical storage unit, a solid state storage unit, an electronic storage units (main memory), or a similar storage unit. Persistent storage may also be a monolithic/single device or a distributed set of devices.

In some aspects, the plurality of devices 104-114 may include any suitable type of computing device or machine that has a programmable processor including, for example, server computers, desktop computers, laptop computers, tablet computers, smartphones, set-top boxes, etc. The plurality of devices 104-114 may each execute or include an operating system (OS). The OS may manage the execution of other components (e.g., software, applications, etc.) and/or may manage access to the hardware (e.g., processors, memory, storage devices etc.) of a device in the plurality of devices 104-114.

The decentralized hierarchical control plane 102 may include a zeroth layer 116, a first layer 118, and a second layer 120 (referred to hereafter as a plurality of layers 116-120). The zeroth layer 116 may include/be associated with the sixth device 114. The first layer 118 may include/be associated with the first device 104 and the second device 106. The second layer 120 may include/be associated with the third device 108, the fourth device 110, and the fifth device 112. Although the example in the block diagram 100 depicts the zeroth layer 116 as including one device, the first layer 118 as including two devices, and the second layer 120 as including three devices, it is to be understood that each layer may include any number of devices. For example, the first layer 118 may include more devices than devices of the second layer 120 or the first layer 118 may include the same number of devices than devices of the second layer 120. In another example, the zeroth layer 116 may include more devices than devices of the first layer 118 or the zeroth layer 116 may include the same number of devices than devices of the first layer 118. Furthermore, although the example in the block diagram 100 depicts three layers, it is to be understood that the decentralized hierarchical control plane 102 may include at least two layers (e.g., two layers, four layers, ten layers, etc.). In some aspects, a number of layers in the decentralized hierarchical control plane 102 may be dynamically increased or dynamically decreased by device(s) in the decentralized hierarchical control plane 102 based on condition(s) (e.g., resource availability, system demand, etc.).

In a layer in the decentralized hierarchical control plane 102, a device may act as a control node. A device may be configured to act as the control node or the device may begin to operate as the control node upon obtaining an indication. In general, a device acting as a control node in a layer manages resource(s) of device(s) in a layer located beneath the device. For example, in the decentralized hierarchical control plane 102 depicted in FIG. 1, the first device 104 acts as a control node 122a for the first layer 118 and the sixth device 114 acts as a control node 122b for the zeroth layer 116. As such, the first device 104 (acting as the control node 122a) manages resources of the third device 108, the fourth device 110, and the fifth device 112 and the sixth device 114 (acting as the control node 122b) manages resources of the first device 104 and the second device 106. Managing resources of a device (e.g., resources of the third device 108) may include managing compute resources, network resources, virtualization associated resources, cloud resources, power resources, and/or workloads.

In some aspects, managing resources may be based on data received from a device from a higher layer in the decentralized hierarchical control plane 102, data received from a lower layer in the decentralized hierarchical control plane 102, data from a sensor of a device, and/or computations performed by the device. In one example, the first device 104 may manage resources of the third device 108, the fourth device 110, and/or the fifth device 112 based on data received from the third device 108, the fourth device 110, and/or the fifth device 112. In another example, the first device 104 may manage resources of the third device 108, the fourth device 110, and/or the fifth device 112 based on data received from the sixth device 114. In a further example, the first device 104 may manage resources of the third device 108, the fourth device 110, and/or the fifth device 112 based on data from a sensor of the first device 104. In yet another example, the first device 104 may manage resources of the third device 108, the fourth device 110, and/or the fifth device 112 based on computations performed by the first device 104. The computations may be based on the data received from a lower layer described above, the data received from a higher layer described above, and/or the sensor data described above.

In some aspects, a device acting as a control node in the decentralized hierarchical control plane 102 may perform functions in addition to managing devices in a lower layer of the decentralized hierarchical control plane 102. For instance, the first device 104, when acting as the control node 122a, may manage device(s) in the second layer 120 while also hosting (i.e., executing), workloads scheduled by the sixth device 114 acting as the control node 122b.

In some aspects, each device in a layer in the plurality of layers 116-120 is the same device type. For example, the first device 104 and the second device 106 may both be edge devices. In some aspects, a layer in the plurality of layers 116-120 may include different device types. For example, the first device 104 may be an IoT device and the second device 106 may be a device associated with a cloud infrastructure.

In some aspects, the plurality of layers 116-120 may be based on a geographic region, a device type, a device capability, and/or a device use. In an example with respect to geographic region, the zeroth layer 116 may be associated with a first geographic region (e.g., the sixth device 114 may be located in the first geographic region), the first layer 118 may be associated with a second geographic region (e.g., the first device 104 and the second device 106 may be located in the second geographic region), and the second layer 120 may be associated with a third geographic region (e.g., the third device 108, the fourth device 110, and the fifth device 112 may be located in the third geographic region). In some aspects, the first geographic region may be larger than the second geographic region and the second geographic region may be larger than the third geographic region. Additionally or alternatively, in some aspects, the first geographic region encompasses the second geographic region and the second geographic region encompasses the third geographic region. In another example with respect to device type, the zeroth layer 116 may include devices associated with a cloud infrastructure, the first layer 118 may include edge computing devices, and the second layer 120 may include IoT devices.

In some aspects, a device in a layer in the decentralized hierarchical control plane 102 may transition to a different layer (e.g., a higher layer or a lower layer than a current layer) in the decentralized hierarchical control plane 102 based on data received from another layer, sensor data, data received from other devices in the layer, and/or computations. In an example, the first device 104 may obtain an indication that the first device 104 is to transition to the second layer 120 (or another layer). In an example, the indication may be received from the sixth device 114. In another example, the indication may be obtained based on a computation performed by the first device 104. The first device 104 may transition from the first layer 118 to the second layer 120 based on the indication. In some aspects, the first device 104 may continue to act as a control node after transitioning. For instance, subsequent to transitioning to a new layer (e.g., the zeroth layer 116, the second layer 120, etc.), the first device 104 may obtain, from a higher layer in the decentralized hierarchical control plane 102, a configuration that configures the first device 104 to act as a control node in the new layer. In some other aspects, the first device 104 ceases to act as a control node after transitioning.

Although the description of FIG. 1 above describes the decentralized hierarchical control plane 102 in a top-to-bottom manner, that is, devices in lower layers are managed by devices in upper layers, other possibilities are contemplated. In some aspects, the devices in the upper layers are managed by devices in the lower levels (i.e., a bottom-to-top manner).

In some aspects, the decentralized hierarchical control plane 102 may be part of a decentralized hierarchy. The decentralized hierarchy may include the decentralized hierarchical control plane 102 and a non-control plane 124, where the decentralized hierarchical control plane 102 and the non-control plane 124 may form a network. The non-control plane 124 may include non-control plane devices 126. The non-control plane devices 126 may be identical to or similar to any of the devices described herein; however, the non-control plane devices 126 may not be considered to be candidate control nodes in the decentralized hierarchical control plane 102. A control node may manage the non-control plane devices 126 in a manner similar to that described above for devices in lower layers of the decentralized hierarchical control plane 102. For instance, the first device 104 may manage the non-control plane devices 126 as described herein. In some aspects, a device may exit the non-control plane 124 and enter the decentralized hierarchical control plane 102 or the device may exit the decentralized hierarchical control plane 102 and enter the non-control plane 124. In an example, the second device 106 may exit the decentralized hierarchical control plane 102 and enter the non-control plane 124, thus becoming part of the non-control plane devices 126. Entering and/or exiting the decentralized hierarchical control plane 102 and/or the non-control plane 124 may be based on a variety of factors, such as resource availability, network conditions, and/or system demands.

In an example, the third device 108 (or another device in the decentralized hierarchical control plane 102 and/or a device in the non-control plane 124) may be associated with a workload 128. For instance, the third device 108 may be scheduled to execute the workload 128 (via the decentralized hierarchical control plane 102) and/or the third device 108 may currently be executing the workload 128. As used herein, the term workload refers to a computational task executed by a processing device. In an example, the workload 128 may include gathering data and/or processing data collected by sensors of devices in the decentralized hierarchical control plane 102 and/or the non-control plane 124. In an example, the workload 128 may include training a machine learning (ML) model and/or using the trained ML model for inference. In some aspects, the workload 128 may be associated with a device transmitting and/or receiving data to device(s) in the decentralized hierarchical control plane 102, device(s) in the non-control plane 124, and/or device(s) not included in the decentralized hierarchical control plane 102 and/or the non-control plane 124.

In an example, a situation occurs which may prevent the third device 108 from executing the workload 128, which may prevent the third device 108 from continuing to execute the workload 128, and/or which may prevent the third device 108 from executing the workload 128 while meeting a set of metrics (e.g., an acceptable latency, an acceptable processing time, having sufficient storage, etc.) associated with workloads. Device(s) in the decentralized hierarchical control plane 102 may detect the situation via monitoring of the third device 108 and/or via transmission(s) received from the third device 108. In an example, the third device 108 may have a low battery level which may prevent the third device 108 from executing the workload 128 and/or prevent the third device 108 from continuing to execute the workload 128. In example, the third device 108 may be scheduled to execute a second workload (not depicted in FIG. 1) that has a higher priority than a priority of the workload 128, thus preventing third device 108 from executing the workload 128 and/or preventing the third device 108 from continuing to execute the workload 128. In another example, a policy (e.g., a geographic restriction policy) of the third device 108 may prevent the third device 108 from executing the workload 128 and/or prevent the third device 108 from continuing to execute the workload 128. In an example, conditions of a network that includes the decentralized hierarchical control plane 102 and the non-control plane 124 may cause latency between the third device 108 and other devices in the network to reach an unacceptable level, and hence the third device 108 may not be able to meet the set of metrics.

The decentralized hierarchical control plane 102 (or a portion thereof) may obtain an indication of the workload 128. For example, the first device 104 (acting as the control node 122a in the decentralized hierarchical control plane 102) may obtain the indication of the workload 128. For example, the first device 104 may obtain the indication of the workload 128 via monitoring the third device 108 and/or the first device 104 may obtain the indication of the workload 128 via a transmission received from the third device 108 or via a transmission received by the first device 104 from another device (e.g., another device in the decentralized hierarchical control plane 102 and/or in the non-control plane 124). The indication of the workload 128 may include an identifier of the workload 128, an identity of a device (e.g., the third device 108) associated with the workload 128, a set of acceptable metrics (e.g., an acceptable latency, an acceptable completion time, etc.) associated with the workload 128, a set of current metrics (e.g., a current latency, a current estimated completion time, etc.) associated with a current or a predicted execution of the workload 128, instructions for performing the workload 128, and/or partial results of the workload 128. In some aspects, the indication of the workload 128 may include an indication that the workload 128 is to be migrated (e.g., due to the above-described situations). In some aspects, the indication of the workload 128 may include a policy associated with the workload and/or a device (e.g., the third device 108) associated with the workload 128. For example, the indication that the workload 128 is to be migrated may be based on the third device 108 detecting a low battery level. Other devices in the decentralized hierarchical control plane 102 may also obtain the indication of the workload 128 as described above.

The decentralized hierarchical control plane 102 (or a portion thereof) may determine that the workload 128 is to be migrated based on the indication of the workload 128. For example, the first device 104 (acting as the control node 122a in the decentralized hierarchical control plane 102) and/or other devices in the decentralized hierarchical control plane 102 may determine that the workload 128 is to be migrated based on the indication of the workload 128. In an example, the indication of the workload 128 may indicate that the workload 128 is to be migrated (e.g., based on low battery life of the third device 108) and the first device 104 may determine that the workload 128 is to be migrated based on the indication that the workload 128 is to be migrated. In another example, the first device 104 may determine that the workload 128 is to be migrated based on one or more of the set of current metrics not meeting one or more of the set of acceptable metrics.

Concurrently with or subsequent to determining that the workload 128 is to be migrated, the decentralized hierarchical control plane 102 (or a portion thereof) may determine a target (e.g., from amongst a plurality of targets) for migrating the workload 128 based on data associated with the decentralized hierarchy (e.g., data associated with the decentralized hierarchical control plane 102 and/or data associated with the non-control plane 124). For example, the first device 104 may determine the target for migrating the workload 128 based on the data associated with the decentralized hierarchy. The decentralized hierarchical control plane 102 may also determine a route (e.g., from amongst a plurality of routes) for migrating the workload 128 to the target based on data associated with the decentralized hierarchy. For example, the first device 104 may determine the route for migrating the workload 128 to the target based on the data associated with the decentralized hierarchy. The target may include a control node in the decentralized hierarchical control plane, a non-control node (e.g., a device in the non-control plane devices 126 and/or a device in the decentralized hierarchical control plane 102 not currently acting as a control node), an edge device in the decentralized hierarchy, cloud computing resources associated with the decentralized hierarchy, and/or a virtual machine (VM) associated with the decentralized hierarchy.

In some aspects, the decentralized hierarchical control plane 102 (or a portion thereof, such as the first device 104) may determine the target for migrating the workload 128 concurrently with determining the route for migrating the workload 128 to the target. In some aspects, the decentralized hierarchical control plane 102 (or a portion thereof, such as the first device 104) may first determine the target for migrating the workload 128 and then subsequently determine the route to the target.

The decentralized hierarchical control plane 102 (or a portion thereof) may obtain the data associated with the decentralized hierarchy prior to determining that the workload 128 is to be migrated, concurrently with determining that the workload 128 is to be migrated, or subsequent to determining that the workload 128 is to be migrated. In some aspects, the decentralized hierarchical control plane 102 (or a portion thereof) may obtain the data associated with the decentralized hierarchy prior to determining the target for migrating the workload 128 or concurrently with determining the target for migrating the workload 128. In some aspects, the decentralized hierarchical control plane 102 (or a portion thereof) may obtain the data associated with the decentralized hierarchy prior to determining the route for migrating the workload 128 to the target or concurrently with determining the route for migrating the workload 128 to the target.

For example, the first device 104 may obtain the data associated with the decentralized hierarchy (e.g., prior to/concurrently with/subsequent to determining that the workload is to be migrated, prior to/concurrently with determining the target, prior to/concurrently with determining the route to the target, etc.). The data associated with the decentralized hierarchy may be or include resource utilization of at least one of a control node, a non-control node, a virtual machine, or an edge device, network latency associated with the decentralized hierarchy, device capabilities of devices in the decentralized hierarchy, device policies of the devices in the decentralized hierarchy, device locations of the devices in the decentralized hierarchy, and/or load balancing across the decentralized hierarchy.

In some aspects, the data associated with the decentralized hierarchy may pertain to different portions of the decentralized hierarchy. For example, a first portion of the data may pertain to a first portion of the decentralized hierarchy (e.g., a first layer of the decentralized hierarchy, a first device type, a first geographical region, etc.) and a second portion of the data may pertain to a second portion of the decentralized hierarchy (a second layer of the decentralized hierarchy, a second device type, a second geographical region, etc.). Thus, different portions of the data associated with the decentralized hierarchy may represent different views of portions of a network.

In some aspects, the decentralized hierarchical control plane 102 (or a portion thereof, such as the first device 104) may determine the target for migrating the workload 128 based on a consensus of a plurality of control nodes in the decentralized hierarchical control plane 102. For example, the first device 104 may transmit, to one or more control nodes, a vote for a target (e.g., the fourth device 110) for migration of the workload 128. The vote may be based on the data associated with the decentralized hierarchy. The first device 104 may receive, from the one or more control nodes, votes for the target and/or another target (e.g., the fifth device 112, the second device 106, etc.). In some aspects, the vote transmitted by the first device 104 may be based on a first portion of the data associated with the decentralized hierarchy and the votes received by the first device 104 may be based on a second portion of the data associated with the decentralized hierarchy. The first device 104 (and/or the one or more control nodes) may determine the target for migrating the workload 128 based on the votes. For example, the first device 104 (and/or the one or more control nodes) may determine the target for migrating the workload 128 based on the target having the greatest number of votes or a majority of votes.

As indicated above, the target may be one of a plurality of targets for migrating the workload. In some aspects, the decentralized hierarchical control plane 102 (or a portion thereof, such as the first device 104) may weight each of the plurality of targets based on the data associated with the decentralized hierarchy. For example, the first device 104 may determine that a first potential target for migrating the workload 128 is associated with a first network latency and that a second potential target for migrating the workload 128 is associated with a second network latency. The first device 104 may assign a first weight to the first potential target based on the first network latency and a second weight to the second potential target based on the second network latency. In some aspects, the first weight and the second weight may be based on other factors as well (e.g., device capabilities, resource utilization, etc.). The first device 104 may select the first potential target as the target based on the first weight and the second weight. For example, the first device 104 may select the first potential target as the target due to the first weight being greater than the second weight.

In some aspects, the workload 128 may be migrated to a device in a same layer as a layer in which the workload is executing or is scheduled to be executed. For instance, the workload 128 may be migrated within the second layer 120. In some aspects, the workload 128 may be migrated to a device in a different layer in which the workload 128 is executing or is scheduled to be executed. For instance, the workload may be migrated from the second layer 120 to the first layer 118, from the second layer to the zeroth layer 116, etc.

As indicated above, the route may be one of a plurality of routes for migrating the workload to a target. In some aspects, the decentralized hierarchical control plane 102 (or a portion thereof, such as the first device 104) may weight each of the plurality of routes based on the data associated with the decentralized hierarchy. For example, the first device 104 may determine that a first potential route for migrating the workload 128 is associated with a first network latency and that a second potential route for migrating the workload 128 is associated with a second network latency. The first device 104 may assign a first weight to the first potential route based on the first network latency and a second weight to the second potential route based on the second network latency. In some aspects, the first weight and the second weight may be based on other factors as well (e.g., device capabilities, resource utilization, etc.). The first device 104 may select the first potential route as the route for migrating the workload 128 to the target based on the first weight and the second weight. For example, the first device 104 may select the first potential route as the route due to the first weight being greater than the second weight.

In some aspects, the route for migrating the workload 128 may be contained within a layer (i.e., an intra-layer route). For example, the route for migrating the workload 128 may be through devices in the second layer 120. In some aspects, the route for migrating the workload 128 may go through more than one layer. For example, the route for migrating the workload 128 may go through the second layer 120 and the first layer 118.

In some aspects, the decentralized hierarchical control plane 102 (or a portion thereof, such as the first device 104) may establish a baseline state of the decentralized hierarchy. For example, the first device 104 may monitor the decentralized hierarchy over a period of time to establish the baseline state. The baseline state may include resource utilization over the period of time, network latency over the period of time, energy consumption over the period of time, etc. The first device 104 may provide the baseline state and the data associated with the decentralized hierarchy as input to a heuristic procedure and/or an adaptive algorithm (e.g., a machine learning algorithm). As used herein, the term heuristic procedure refers to a procedure that ranks alternatives in an algorithm at branching steps based on available information. As used herein, the term adaptive algorithm may refer to an algorithm that changes structures of parameters in response to new data or environmental changes. The heuristic procedure and/or the adaptive algorithm may output an indication of the target and/or an indication of the route to the target. In some aspects, the heuristic procedure and/or the adaptive algorithm may weight potential targets and/or potential routes. In some aspects, the first device 104 may cast a vote based on the output of the heuristic procedure and/or the adaptive algorithm (using a procedure similar to that described above). In some aspects, votes received by the first device 104 from the one or more control nodes may be based on the heuristic procedure and/or the adaptive algorithm (or another heuristic procedure and/or another adaptive algorithm).

The decentralized hierarchical control plane 102 (or a portion thereof, such as the first device 104) may cause the workload 128 to be migrated to the (determined) target. In some aspects, the decentralized hierarchical control plane 102 (or a portion thereof, such as the first device 104) may cause the workload 128 to be migrated to the (determined) target via the (determined) route. Causing the workload 128 to be migrated to the determined target via the determined route may include transmitting migration data. The migration data may include an indication of the target, an indication of the route, an indication of the workload 128, instructions for performing the workload 128, and/or partial results of the workload from a device that was previously executing the workload 128. The target may receive the migration data and the target may execute the workload 128 based on the migration data. In an example, the route for migrating the workload 128 may be device A (not shown in FIG. 1) to device B (not shown in FIG. 1) to device C (not shown in FIG. 1), where device C is the target. The first device 104 may transmit the migration data to device A. Device A may transmit the migration data to device B. Device B may transmit the migration data to device C, whereupon device C may execute the workload 128 based on the migration data.

Although the description of FIG. 1 above describes a single device acting as a control node for each layer of the decentralized hierarchical control plane 102 (e.g., the first device 104 acts as the control node 122a in the first layer 118 and the sixth device 114 acts as the control node 122b in the zeroth layer 116), other possibilities are contemplated. In some aspects, a layer in the decentralized hierarchical control plane 102 may include more than one control node. Control nodes within a layer may collaborate with one another to manage device(s) in a lower layer in the decentralized hierarchical control plane 102.

Furthermore, although the description of FIG. 1 above describes a single device executing the workload 128 and a single device as being the target for migration of the workload 128, other possibilities are contemplated. In some aspects, the workload 128 is executed by a first group of devices (e.g., in the decentralized hierarchical control plane 102 and/or the non-control plane 124). For instance, each device in the first group of devices may be associated with a portion of the workload and/or each device in the group of first devices may be associated with a respective instance of the workload. In such an aspect, using the procedures described herein, the decentralized hierarchical control plane 102 may cause the workload 128 to be migrated to a second group of devices (e.g., in the decentralized hierarchical control plane 102 and/or the non-control plane 124) or to a second device (e.g., in the decentralized hierarchical control plane 102 and/or the non-control plane 124). Alternatively, in some aspects, the workload 128 may be associated with a single device, and using the procedure described herein, the workload 128 may be migrated to the second group of devices.

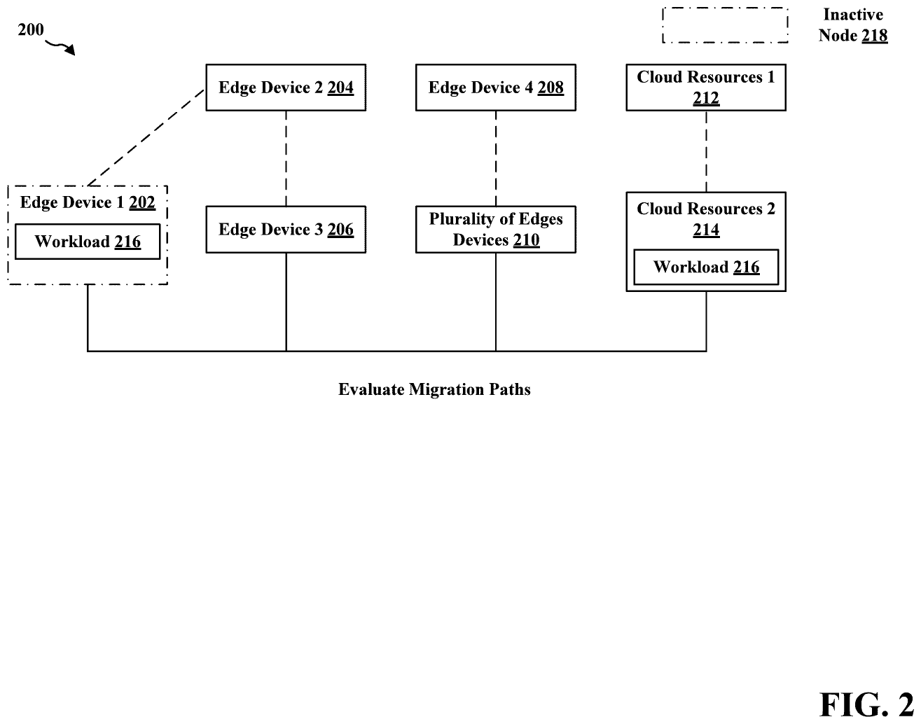

FIG. 2 is a block diagram 200 that illustrates an example of workload migration in accordance with some aspects of the present disclosure. The block diagram 200 depicts a first edge device 202, a second edge device 204, a third edge device 206, a fourth edge device 208, a plurality of edge devices 210, first cloud resources 212, and second cloud resources 214. In an example, the first edge device 202, the second edge device 204, the third edge device 206, the fourth edge device 208, the plurality of edge devices 210, the first cloud resources 212, and/or the second cloud resources 214 may be included in or be associated with the decentralized hierarchical control plane 102 and/or the non-control plane 124. The first edge device 202, the second edge device 204, the third edge device 206, the fourth edge device 208, the plurality of edge devices 210, the first cloud resources 212, and/or the second cloud resources 214 may each be considered to be nodes in a decentralized hierarchy including the decentralized hierarchical control plane 102 and the non-control plane 124.

In an example, the first edge device 202 may be associated with a workload 216, that is, the first edge device 202 may be scheduled to execute the workload 216 or the first edge device 202 may be currently executing the workload 216. In some aspects, the workload 216 may be or include the workload 128. Prior to executing the workload 216 or as the workload 216 is being executed, the first edge device 202 may become an inactive node 218. For example, the first edge device 202 may run low on battery.

One or more devices in the decentralized hierarchical control plane 102 (e.g., the second edge device 204, the plurality of edge devices 210, the first cloud resources 212, etc.) may evaluate migration paths for the workload 216 as described herein. For instance, the migration paths may be evaluated based on a consensus, based on weights, etc. The one or more devices in the decentralized hierarchical control plane 102 may cause the workload to be migrated to a target as described above. In an example, the one or more devices in the decentralized hierarchical control plane 102 may cause the workload 216 to be migrated from the first edge device 202 to the second cloud resources 214, whereupon the workload 216 may be executed by device(s) associated with the second cloud resources 214.

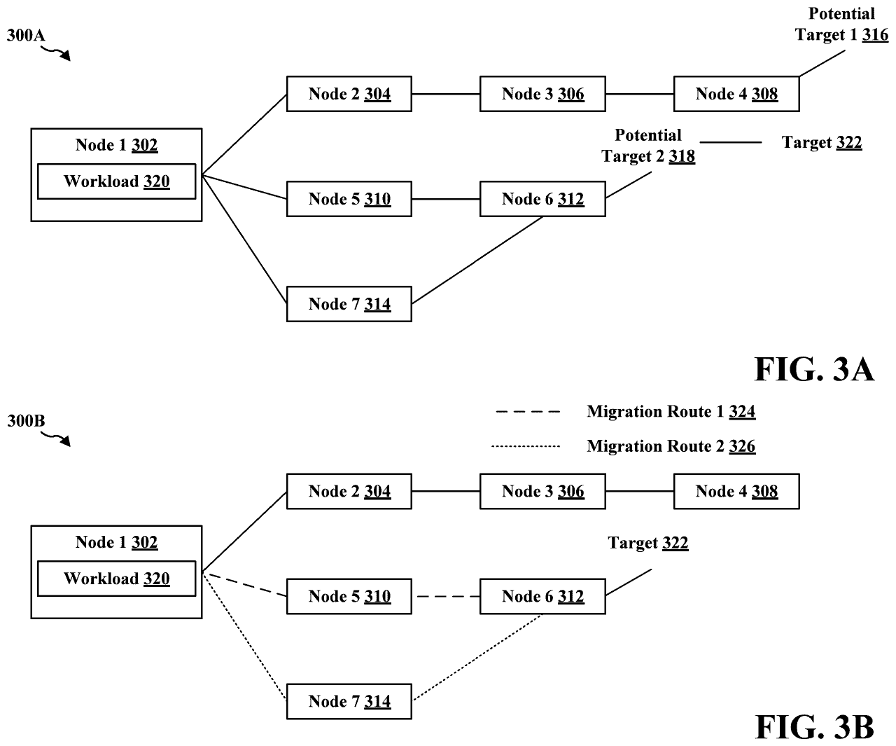

FIG. 3A is a block diagram 300A that illustrates an example of determining a target for migrating a workload in accordance with some aspects of the present disclosure. The block diagram 300A depicts a first node 302, a second node 304, a third node 306, a fourth node 308, a fifth node 310, a sixth node 312, and a seventh node 314. In an example, the first node 302, the second node 304, the third node 306, the fourth node 308, the fifth node 310, the sixth node 312, and/or the seventh node 314 may be included in the decentralized hierarchical control plane 102 and/or the non-control plane 124. In an example, the first node 302, the second node 304, the third node 306, the fourth node 308, the fifth node 310, the sixth node 312, and/or the seventh node 314 may be or include edge devices and/or cloud resources, such as the edge devices and/or cloud resources depicted in FIG. 2. In an example, the first node 302, the second node 304, the third node 306, the fourth node 308, the fifth node 310, the sixth node 312, and/or the seventh node 314 may be included in the same layer or different layer(s) in the decentralized hierarchical control plane 102. In the block diagram 300A, communication links (e.g., a wireless local area network (WLAN) link, a local area network (LAN) link, a Bluetooth® link, a cellular communication link, etc.) are indicated by lines between nodes. For example, the first node 302 may communicate directly with the second node 304 via a communication link; however, in order to communicate with the third node 306, the first node 302 may communicate with the third node 306 via the second node 304.

As described herein, the decentralized hierarchical control plane 102 (or a portion thereof) may determine a first potential target 316 and a second potential target 318 for migrating a workload 320. In an example, device(s) in the decentralized hierarchical control plane 102 may select the second potential target 318 as a target 322 (i.e., as “the target”) for migrating the workload 320 based on data associated with the decentralized hierarchy and/or a consensus of nodes/devices in the decentralized hierarchical control plane 102.

FIG. 3B is a block diagram 300B that illustrates an example of determining a route for migrating a workload to a target in accordance with some aspects of the present disclosure. The block diagram 300B depicts the first node 302, the second node 304, the third node 306, the fourth node 308, the fifth node 310, the sixth node 312, and/or the seventh node 314 as described above in the description of FIG. 3A. As described herein, the decentralized hierarchical control plane 102 (or a portion thereof) may determine a first migration route 324 and a second migration route 326 for migrating a workload 320. In an example, the first migration route 324 includes/is associated with the fifth node 310 and the sixth node 312, whereas the second migration route 326 includes/is associated with the seventh node 314 and the sixth node 312. In an example, device(s) in the decentralized hierarchical control plane 102 may select the first migration route 324 as a route (i.e., as “the target migration route”) for migrating the workload 320 based on data associated with the decentralized hierarchy and/or a consensus of nodes/devices in the decentralized hierarchical control plane 102. The decentralized hierarchical control plane 102 may cause the workload 320 to be migrated via the first migration route 324.

Centralized control planes for virtualization management may struggle to handle the scale and diverse capability of edge devices, such as when an Edge is deployed alongside a hybrid cloud strategy. A decentralized control plane may effectively handle management of virtualization resources in such scenarios. However, in a decentralized control plane, efficient migration of workloads between virtual machines (VMs) across edge devices and hybrid cloud environments may facilitate optimizing resource utilization, maintaining system performance, and ensuring seamless service continuity. An effective workload migration mechanism that is able to adapt to varying network conditions, device capability, and/or system demands may facilitate optimizing resource utilization, maintaining system performance, and ensuring seamless service continuity.

An intelligent workload migration decision making mechanism is described herein. In an example, the intelligent workload migration decision making mechanism for a decentralized hierarchical control plane architecture efficiently determines an optimal migration strategy for workloads between VMs across edge devices and a hybrid cloud infrastructure. The intelligent workload migration decision making mechanism may be based on “on-the-fly” learning approaches and may heavily leverage distributed decision making capability of a decentralized hierarchical control plane. Via gathering real-time data (e.g., resource utilization, network latency, device capabilities, etc.) from control nodes, VMs, and/or edge devices, the decentralized hierarchical control plane may establish a constant baseline for a network. The decentralized hierarchical control plane may provide the aforementioned gathered real-time data into an “on-the-fly” learning approach, such as an adaptive algorithm and/or a heuristic method. Furthermore, via the “on-the-fly” learning approach, the decentralized hierarchical control plane analyzes the aforementioned gathered real-time data and determines an optimal migration strategy for a workload through destination options (i.e., targets) that can be weighted. The “on-the-fly” learning approach may utilize an algorithm that is fine tuned to consider factors such as VM resource utilization, network conditions, device policies (e.g., which workloads can run due to legal or compliance restrictions), energy consumption of an edge node, and/or load balancing across devices. The decentralized hierarchical control plane, as a distributed entity, may have the collective intelligence of multiple nodes and may evaluate an impact across a plurality of potential migration targets and may apply weighting to a decision pertaining to migrating the workload.

In some aspects, the decentralized hierarchical control plane may utilize a consensus mechanism that may ensure that migration decisions made by control nodes are validated, reliable, and consistent across an entire system and may avoid challenges associated with unclear telemetry data. When a control node proposes a workload migration decision, other control nodes within the system participate in a validation process. The other control nodes may review the workload migration decision based on their respective knowledge of a system state, resource availability, and/or other data available to the other control nodes. Reviewing the workload migration decision in such a manner may ensure that a potential race condition, such as a node going offline, is accounted for by having localized information validating a course of action (i.e., validating the workload migration decision). The intelligent workload migration decision making mechanism may include multiple workload migration proposals that may ensure an optimal, just-in-time workload migration decision is made. In some aspects, the workload migration decision may be federated across multiple clusters of nodes within the decentralized hierarchical control plane and may provide for workload migration between the multiple clusters on an edge and a cloud depending on circumstances.

In contrast to some approaches for migrating workloads that rely on static rules or predetermined policies, the intelligent workload migration decision making mechanism described herein leverages “on-the-fly” learning approaches which dynamically adapt to changing network conditions, device capabilities, and/or system demands. The intelligent workload migration decision making mechanism described herein may provide for the execution of workloads when edge devices have difficulty staying operational (e.g., due to limited battery life, communication channel interference, etc.).

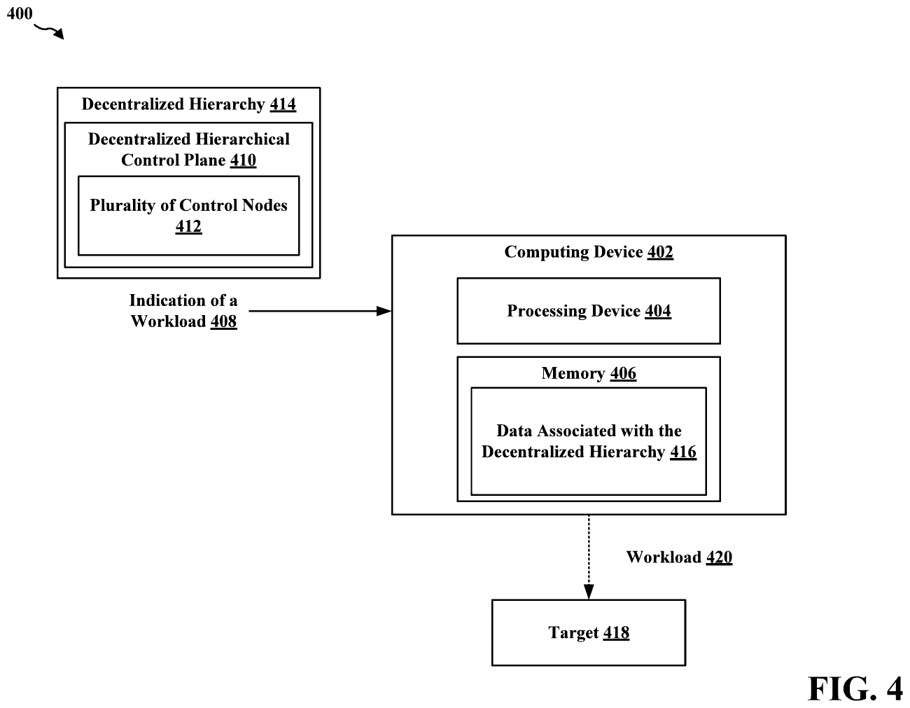

FIG. 4 is a block diagram 400 that illustrates an example system in accordance with some aspects of the present disclosure. The system includes a computing device 402. The computing device 402 includes a processing device 404 and a memory 406. The processing device 404 is operatively coupled to the memory 406.

The processing device 404 is to obtain an indication of a workload 408 associated with a decentralized hierarchical control plane 410, where the decentralized hierarchical control plane 410 includes a plurality of control nodes 412 in a decentralized hierarchy 414. The processing device 404 is to determine, based on data associated with the decentralized hierarchy 416, a target 418 for migration of the workload 420. The processing device 404 is to cause the workload 420 to be migrated to the target 418.

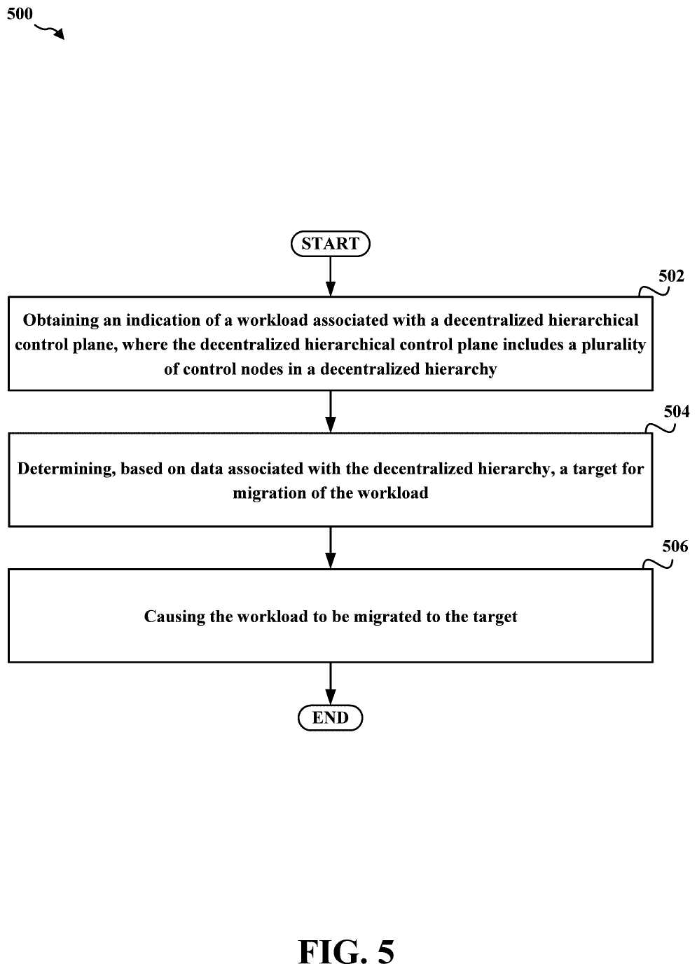

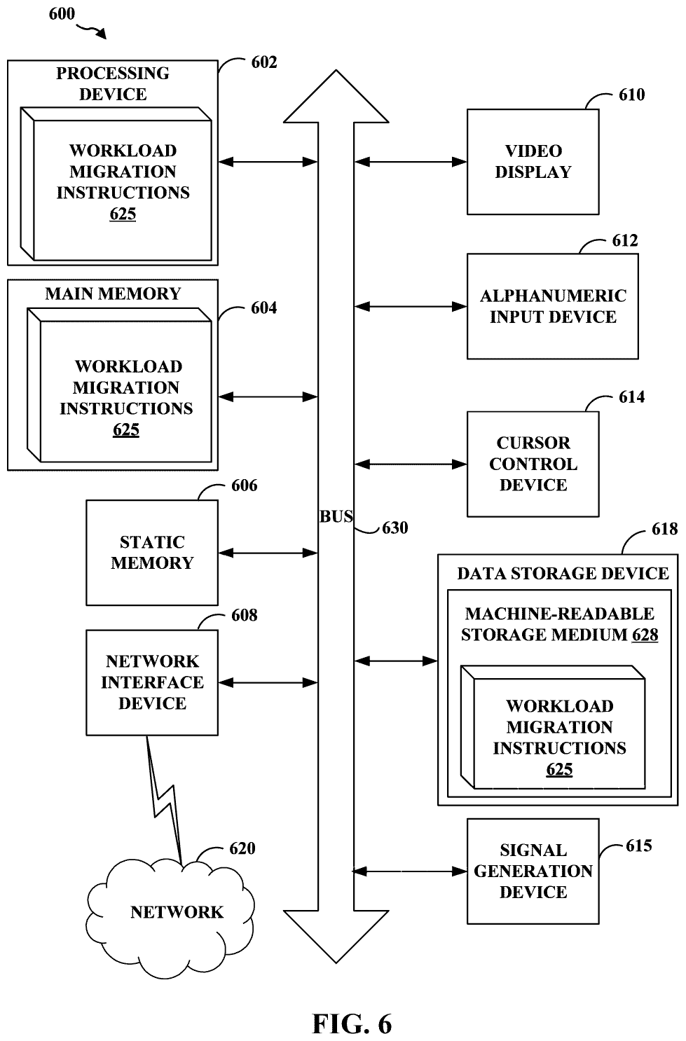

FIG. 5 is a flow diagram of a method 500 for workload migration in accordance with some aspects of the present disclosure. The method 500 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some aspects, the method 500 may be performed by a computing device (e.g., a device acting as a control node in FIG. 1, an edge device or device(s) associated with cloud resources in FIG. 2, a node as in FIG. 3A or FIG. 3B, the computing device 402 in FIG. 4, the computer system 600 in FIG. 6, etc.).

At block 502, a processing device obtains an indication of a workload associated with a decentralized hierarchical control plane, where the decentralized hierarchical control plane includes a plurality of control nodes in a decentralized hierarchy. For example, the workload may be or include the workload 128, the workload 216, the workload 320, and/or the workload 420. In an example, the decentralized hierarchical control plane may be or include the decentralized hierarchical control plane 102. In an example, the plurality of control nodes may be or include the first device 104, the second device 106, the third device 108, the fourth device 110, the fifth device 112, and/or the sixth device 114. In another example, the plurality of control nodes may be or include the first node 302, the second node 304, the third node 306, the fourth node 308, the fifth node 310, the sixth node 312, and/or the seventh node 314. In a further example, the plurality of control nodes may include one or more edge devices and/or cloud resources described above in the description of FIG. 4. In an example, the decentralized hierarchy may include the decentralized hierarchical control plane 102 and the non-control plane 124.

At block 504, the processing device determines, based on data associated with the decentralized hierarchy, a target for migration of the workload. In an example, the target may be or include the target 322. In an example, the data associated with the decentralized hierarchy may be or include the data associated with the decentralized hierarchy described above in the description of FIG. 1, FIG. 2, FIG. 3A, FIG. 3B, and/or FIG. 4.

At block 506, the processing device causes the workload to be migrated to the target. For example, FIG. 3B shows that a processing device may cause the workload to be migrated to the target 322.

In some aspects, determining the target for the migration of the workload may include determining the target for the migration of the workload based on a consensus of the plurality of control nodes, where the consensus may be based on the data associated with the decentralized hierarchy. For example, the consensus may be based on a consensus of nodes in the decentralized hierarchical control plane 102.

In some aspects, the target may include at least one of: a control node in the plurality of control nodes, a non-control node in the decentralized hierarchy, an edge device in the decentralized hierarchy, cloud computing resources associated with the decentralized hierarchy, or a virtual machine associated with the decentralized hierarchy. For example, the aforementioned aspect may be associated with the description of FIG. 1 above.

In some aspects, the target may be one a plurality of targets, where each of the plurality of targets may be associated with a weight from a set of weights, and where determining the target for the migration of the workload may be based on the set of weights. For example, the aforementioned aspect may be associated with the description of FIG. 1 above. In an example, the plurality of targets may include the first potential target 316 and the second potential target 318.

In some aspects, the processing device may determine, based on the data associated with the decentralized hierarchy, a route to the target, where causing the workload to be migrated to the target may include causing the workload to be migrated to the target via the route. For example, the aforementioned aspect may be associated with the description of FIG. 1 above.

In some aspects, the route may be one a plurality of routes, where each of the plurality of routes may be associated with a weight from a set of weights, and where determining the route for the migration of the workload may be based on the set of weights. For example, the plurality of routes may include the first migration route 324 and the second migration route 326.

In some aspects, determining the route to the target may include determining the route to the target based on a consensus of the plurality of control nodes, where the consensus may be based on the data associated with the decentralized hierarchy. For example, the aforementioned aspect may be associated with the description of FIG. 1 and/or FIG. 3B described above.

In some aspects, the processing device may obtain the associated with the decentralized hierarchy from at least one of a control node of the decentralized hierarchy or a non-control node of the decentralized hierarchy, where determining the target for the migration of the workload may additionally be based on the obtained data. For example, the aforementioned aspect may be associated with the description of FIG. 1 above.

In some aspects, the data associated with the decentralized hierarchy may include at least one of: resource utilization of at least one of a control node, a non-control node, a virtual machine, or an edge device, network latency associated with the decentralized hierarchy, device capabilities of devices in the decentralized hierarchy, device policies of the devices in the decentralized hierarchy, device locations of the devices in the decentralized hierarchy, energy consumption in the decentralized hierarchy, or load balancing across the decentralized hierarchy. For example, the aforementioned aspect may be associated with the description of FIG. 1 above.

In some aspects, determining the target for the migration of the workload may include transmitting, to at least one control node in the plurality of control nodes, a vote for a first proposed target for the migration of the workload and receiving, from the at least one control node in the plurality of control nodes, votes for a second proposed target for the migration of the workload, where determining the target for the migration of the workload may include determining the target based on the vote and the votes. For example, the aforementioned aspect may be associated with the description of FIG. 1 above.

In some aspects, obtaining the indication of the workload associated with the decentralized hierarchical control plane may include obtaining the indication of the workload based on a device executing the workload in the decentralized hierarchy becoming inactive or based on the device being predicted to become inactive, and where causing the workload to be migrated to the target may include causing the workload to be migrated from the device to the target responsive to determining the target for the migration of the workload. For example, the device becoming inactive or predicted to become inactive may correspond to the inactive node 218 in FIG. 2.

In some aspects, causing the workload to be migrated to the target may include causing the workload to be migrated from a first layer of the decentralized hierarchy to a second layer of the decentralized hierarchy. For example, the first layer and the second layer may be layers described above in the description of FIG. 1.

In some aspects, the processing device may establish a baseline state of the decentralized hierarchy, where determining the target for the migration of the workload may include providing the baseline state and the data associated with the decentralized hierarchy as input to at least one of a heuristic procedure or a machine learning (ML) model and obtaining, as an output of at least one of the heuristic procedure or the ML model, an indication of the target for the migration. For example, the aforementioned aspect may be associated with the description of FIG. 1 above.

In some aspects, obtaining the indication of the workload, determining the target for the migration of the workload, and causing the workload to be migrated to the target may be performed by a control node in the plurality of control nodes, where the control node may possess a state of the decentralized hierarchy, and where the state is less than a full state of the decentralized hierarchy. For example, the aforementioned aspect may be associated with the description of FIG. 1 above.

In some aspects, the decentralized hierarchy may include a plurality of clusters including a first cluster includes edge devices and a second cluster including cloud devices, and where causing the workload to be migrated to the target may include causing the workload to be migrated to the first cluster to the second cluster, or vice versa. For example, the first cluster may include the plurality of edge devices 210 and the second cluster may include cloud devices associated with the first cloud resources 212 and/or the second cloud resources 214.

FIG. 6 illustrates a diagrammatic representation of a machine in the example form of a computer system 600 within which a set of instructions, for causing the machine to perform any one or more of the methodologies discussed herein for dynamic workload migration in a decentralized hierarchical control plane for management in edge devices and hybrid cloud environments. More specifically, the machine may obtain an indication of a workload associated with a decentralized hierarchical control plane, where the decentralized hierarchical control plane includes a plurality of control nodes in a decentralized hierarchy; determine, based on data associated with the decentralized hierarchy, a target for migration of the workload, and cause the workload to be migrated to the target.

In alternative aspects, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or a bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one aspect, the computer system 600 may be representative of a server.

The computer system 600 includes a processing device 602, a main memory 604 (e.g., read-only memory (ROM), flash memory, dynamic random access memory (DRAM), a static memory 606 (e.g., flash memory, static random access memory (SRAM), etc.), and a data storage device 618, which communicate with each other via a bus 630. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

The computer system 600 may further include a network interface device 608 which may communicate with a network 620. The computer system 600 also may include a video display unit 610 (e.g., a liquid crystal display (LCD) or a cathode ray tube (CRT)), an alphanumeric input device 612 (e.g., a keyboard), a cursor control device 614 (e.g., a mouse), and a signal generation device 615 (e.g., a speaker). In one example, the video display unit 610, the alphanumeric input device 612, and the cursor control device 614 may be combined into a single component or device (e.g., an LCD touch screen).

The processing device 602 represents one or more general-purpose processing devices such as a microprocessor, a central processing unit, or the like. More particularly, the processing device 602 may be a complex instruction set computing (CISC) microprocessor, a reduced instruction set computer (RISC) microprocessor, a very long instruction word (VLIW) microprocessor, or a processor implementing other instruction sets, or processors implementing a combination of instruction sets. The processing device 602 may also be one or more special-purpose processing devices such as an application specific integrated circuit (ASIC), a field programmable gate array (FPGA), a digital signal processor (DSP), a network processor, or the like. The processing device 602 is configured with workload migration instructions 625, for performing the operations and steps discussed herein. For example, the workload migration instructions 625 may include instructions for obtaining an indication of a workload associated with a decentralized hierarchical control plane, where the decentralized hierarchical control plane includes a plurality of control nodes in a decentralized hierarchy. The workload migration instructions 625 may further include instructions for determining, based on data associated with the decentralized hierarchy, a target for migration of the workload. The workload migration instructions 625 may further include instructions for causing the workload to be migrated to the target.

The data storage device 618 may include a machine-readable storage medium 628 storing workload migration instructions 625 (e.g., software) embodying any one or more of the methodologies of functions described herein. The workload migration instructions 625 may also reside, completely or partially, within the main memory 604 or within the processing device 602 during execution thereof by the computer system 600; the main memory 604 and the processing device 602 also constituting machine-readable storage media. The workload migration instructions 625 may further be transmitted or received over the network 620 via the network interface device 608.

The machine-readable storage medium 628 may also be used to store the workload migration instructions 625 to perform a method for dynamic workload migration in a decentralized hierarchical control plane for management in edge devices and hybrid cloud environments, as described herein. While the machine-readable storage medium 628 is shown in an exemplary aspect to be a single medium, the term “machine-readable storage medium” should be taken to include a single medium or multiple media (e.g., a centralized or distributed database, or associated caches and servers) that store the one or more sets of instructions. A machine-readable storage medium includes any mechanism for storing information in a form (e.g., software, processing application) readable by a machine (e.g., a computer). The machine-readable storage medium may include, but is not limited to, a magnetic storage medium (e.g., floppy diskette), an optical storage medium (e.g., CD-ROM), a magneto-optical storage medium, a read-only memory (ROM), random-access memory (RAM), erasable programmable memory (e.g., EPROM and EEPROM), flash memory, or another type of medium suitable for storing electronic instructions.

The preceding description sets forth numerous specific details such as examples of specific systems, components, methods, and so forth, in order to provide a good understanding of several aspects of the present disclosure. It will be apparent to one skilled in the art, however, that at least some aspects of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular aspects may vary from these exemplary details and still be contemplated to be within the scope of the present disclosure.

Additionally, some aspects may be practiced in distributed computing environments where the machine-readable medium is stored on and or executed by more than one computer system. In addition, the information transferred between computer systems may either be pulled or pushed across the communication medium connecting the computer systems.

Aspects of the claimed subject matter include, but are not limited to, various operations described herein. These operations may be performed by hardware components, software, firmware, or a combination thereof.

Although the operations of the methods herein are shown and described in a particular order, the order of the operations of each method may be altered so that certain operations may be performed in an inverse order or so that certain operation may be performed, at least in part, concurrently with other operations. In another aspect, instructions or sub-operations of distinct operations may be in an intermittent or alternating manner.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an aspect” or “one aspect” or “an implementation” or “one implementation” throughout is not intended to mean the same aspect or implementation unless described as such. Furthermore, the terms “first,” “second,” “third,” “fourth,” etc. as used herein are meant as labels to distinguish among different elements and may not necessarily have an ordinal meaning according to their numerical designation. Unless specifically stated otherwise, terms such as “obtaining,” “determining,” “causing,” “transmitting,” “receiving,” “identifying,” “establishing,” “providing,” “inputting,” “outputting,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices.

It will be appreciated that variants of the above-disclosed and other features and functions, or alternatives thereof, may be combined into may other different systems or applications. Various presently unforeseen or unanticipated alternatives, modifications, variations, or improvements therein may be subsequently made by those skilled in the art which are also intended to be encompassed by the following claims. The claims may encompass aspects in hardware, software, or a combination thereof.

What is claimed is:

1. A method, comprising:
obtaining an indication of a workload associated with a decentralized hierarchical control plane, wherein the decentralized hierarchical control plane comprises a plurality of control nodes in a decentralized hierarchy;
determining, by a processing device and based on data associated with the decentralized hierarchy, a target for migration of the workload; and
causing the workload to be migrated to the target.

2. The method of claim 1, wherein determining the target for the migration of the workload comprises determining the target for the migration of the workload based on a consensus of the plurality of control nodes, wherein the consensus is based on the data associated with the decentralized hierarchy.

3. The method of claim 1, wherein the target comprises at least one of:
a control node in the plurality of control nodes,
a non-control node in the decentralized hierarchy,
an edge device in the decentralized hierarchy,
cloud computing resources associated with the decentralized hierarchy, or
a virtual machine associated with the decentralized hierarchy.

4. The method of claim 1, wherein the target is one a plurality of targets, wherein each of the plurality of targets is associated with a weight from a set of weights, and wherein determining the target for the migration of the workload is based on the set of weights.

5. The method of claim 1, further comprising:
determining, based on the data associated with the decentralized hierarchy, a route to the target, wherein causing the workload to be migrated to the target comprises causing the workload to be migrated to the target via the route.

6. The method of claim 5, wherein the route is one a plurality of routes, wherein each of the plurality of routes is associated with a weight from a set of weights, and wherein determining the route for the migration of the workload is based on the set of weights.

7. The method of claim 5, wherein determining the route to the target comprises determining the route to the target based on a consensus of the plurality of control nodes, wherein the consensus is based on the data associated with the decentralized hierarchy.

8. The method of claim 1, further comprising:
obtaining the data associated with the decentralized hierarchy from at least one of a control node of the decentralized hierarchy or a non-control node of the decentralized hierarchy, wherein determining the target for the migration of the workload is additionally based on the obtained data.

9. The method of claim 1, wherein the data associated with the decentralized hierarchy comprises at least one of:
resource utilization of at least one of a control node, a non-control node, a virtual machine, or an edge device,
network latency associated with the decentralized hierarchy,
device capabilities of devices in the decentralized hierarchy,
device policies of the devices in the decentralized hierarchy,
device locations of the devices in the decentralized hierarchy,
energy consumption in the decentralized hierarchy, or
load balancing across the decentralized hierarchy.

10. The method of claim 1, wherein determining the target for the migration of the workload comprises:
transmitting, to at least one control node in the plurality of control nodes, a vote for a first proposed target for the migration of the workload; and
receiving, from the at least one control node in the plurality of control nodes, votes for a second proposed target for the migration of the workload, wherein determining the target for the migration of the workload comprises determining the target based on the vote and the votes.

11. The method of claim 1, wherein obtaining the indication of the workload associated with the decentralized hierarchical control plane comprises obtaining the indication of the workload based on a device executing the workload in the decentralized hierarchy becoming inactive or based on the device being predicted to become inactive, and wherein causing the workload to be migrated to the target comprises causing the workload to be migrated from the device to the target responsive to determining the target for the migration of the workload.

12. The method of claim 1, wherein causing the workload to be migrated to the target comprises causing the workload to be migrated from a first layer of the decentralized hierarchy to a second layer of the decentralized hierarchy.

13. The method of claim 1, further comprising:
establishing a baseline state of the decentralized hierarchy, wherein determining the target for the migration of the workload comprises:
providing the baseline state and the data associated with the decentralized hierarchy as input to at least one of a heuristic procedure or a machine learning (ML) model; and
obtaining, as an output of at least one of the heuristic procedure or the ML model, an indication of the target for the migration.

14. The method of claim 1, wherein obtaining the indication of the workload, determining the target for the migration of the workload, and causing the workload to be migrated to the target are performed by a control node in the plurality of control nodes, wherein the control node possesses a state of the decentralized hierarchy, and wherein the state is less than a full state of the decentralized hierarchy.

15. The method of claim 1, wherein the decentralized hierarchy comprises a plurality of clusters including a first cluster comprises edge devices and a second cluster comprising cloud devices, and wherein causing the workload to be migrated to the target comprises causing the workload to be migrated to the first cluster to the second cluster, or vice versa.

16. A system, comprising:
a memory; and
a processing device, operatively coupled to the memory, to:
obtain an indication of a workload associated with a decentralized hierarchical control plane, wherein the decentralized hierarchical control plane comprises a plurality of control nodes in a decentralized hierarchy;
determine, based on data associated with the decentralized hierarchy, a target for migration of the workload; and
cause the workload to be migrated to the target.

17. The system of claim 16, wherein to determine the target for the migration of the workload, the processing device is to determine the target for the migration of the workload based on a consensus of the plurality of control nodes, wherein the consensus is based on the data associated with the decentralized hierarchy.

18. The system of claim 16, wherein the data associated with the decentralized hierarchy comprises at least one of:
resource utilization of at least one of a control node, a non-control node, a virtual machine, or an edge device,
network latency associated with the decentralized hierarchy,
device capabilities of devices in the decentralized hierarchy,
device policies of the devices in the decentralized hierarchy,
device locations of the devices in the decentralized hierarchy,
energy consumption in the decentralized hierarchy, or
load balancing across the decentralized hierarchy.

19. A non-transitory computer-readable medium having instructions stored thereon which, when executed by a processing device, cause the processing device to:
obtain an indication of a workload associated with a decentralized hierarchical control plane, wherein the decentralized hierarchical control plane comprises a plurality of control nodes in a decentralized hierarchy;
determine, by the processing device and based on data associated with the decentralized hierarchy, a target for migration of the workload; and
cause the workload to be migrated to the target.

20. The non-transitory computer-readable medium of claim 19, wherein to determine the target for the migration of the workload, the instructions, when executed by the processing device, cause the processing device to determine the target for the migration of the workload based on a consensus of the plurality of control nodes, wherein the consensus is based on the data associated with the decentralized hierarchy.
